(19) United States
(12) Patent Application Publication
(10) Pub. No.: US 2007/0147049 A1
(43) Pub. Date: Jun. 28, 2007

(54) Leveling of reflector

(76) Inventor: Byron Richard Collins, Tuxedo, NC (US)

Correspondence Address: Timothy E. Nauman, 7th Floor, 1100 Superior Avenue, Cleveland, OH, 44114-2579, US

(21) Appl. No.: 11/318,720

(22) Filed: Dec. 27, 2005

(51) Int. Cl. F21V 7/00

(52) U.S. Cl. 362/347; 362/296

(57) ABSTRACT

A luminaire (10) includes a substrate (40) having a concave interior surface (44). A reflective surface (42) is supported by the substrate. A leveling layer (48) intermediate the substrate and the reflective surface includes a porcelain enamel. A lamp (12), such as a high intensity discharge lamp, illuminates the reflective surface.

### BACKGROUND

The exemplary embodiment relates to the lighting arts. It finds particular application in conjunction with a reflector for a lamp which provides a high beam efficiency and is particularly suited to sporting, roadway, floodlighting, and other applications where the lamp is located at a significant distance from an object to be illuminated.

Luminaires for illuminating roadways and sporting arenas typically include a reflector surface which provides a collimated or highly directional beam of light from a lamp situated adjacent the reflector. A smooth reflector surface is one factor which is desirable for achieving a high beam efficiency. The reflector surface should be as smooth as possible to maximize the amount of specularly reflected light and minimize diffuse reflection. In general, aluminum surfaces only achieve about 60% specular reflection (i.e., about 40% of the reflected light is diffuse) because the sheet aluminum blanks used in forming the reflectors are not perfectly smooth. Some improvements can be made by polishing the surface, which can result in a specular reflection of about 75-85%. Higher reflectances are generally not possible. If the polishing is done before the blank is shaped, the reflector can acquire new imperfections in the shaping process. Moreover, faceted reflectors used in many applications are difficult to polish to high levels of smoothness after shaping. Additionally, the polishing process tends to be time consuming and thus may not be economically feasible for some lighting applications.

In some lighting systems, a metallized coating, such as silver, is applied to a reflector substrate surface. However, the coating is relatively thin and follows the contours of the underlying substrate. Any surface roughness in the reflector substrate is thus transferred to the coating. Thus, specular reflection is not significantly improved.

As an alternative to aluminum, glass reflectors, sometimes with a dichroic coating, have been used as reflectors. Reflectors of this type are disclosed, for example, in U.S. Pat. No. 5,586,015 to Baldwin. However, due to the size of the reflector, luminaires with glass reflectors tend to be heavy and can fracture relatively easily. Plastic has also been used for reflectors, but it tends to be limited to low temperature applications.

To produce a high lumen output, luminaires often employ a high intensity discharge (HID) lamp as a light source. In a high intensity discharge (HID) lamp, a medium to high pressure ionizable gas, such as mercury or sodium vapor and/or a metal halide, emits visible radiation upon excitation. In some HID lamps, an arc is developed between electrodes which are supplied with electrical current. In electrodeless lamps, an arc discharge is generated in the lamp fill by excitation with an RF current in an excitation coil surrounding the arc tube.

HID lamps tend to produce a significant quantity of heat, which is transferred to the reflector of the luminaire by convection and radiation. As a result, the reflector surfaces, particularly those closest to the lamp, tend to become hot during operation. Thus, the reflector surface should be capable of withstanding temperatures of about 200° C. Additionally, luminaires used for sporting and road illumination are often installed in elevated locations where access for replacement is difficult and where the luminaire components are exposed to corrosive environments, such as salt and fog.

There is a need for a reflector which provides a luminaire with a high beam efficiency and which is capable of withstanding temperature cycles from about minus 40° C. to 200° C. and can operate at elevated temperatures for extended periods in corrosive environments.

### BRIEF DESCRIPTION

In one aspect of the exemplary embodiment, a luminaire includes a substrate having a concave interior surface. A reflective surface is supported by the substrate. A leveling layer intermediate the substrate and the reflective surface includes a porcelain enamel. A lamp illuminates the reflective surface.

In another aspect, a method for forming a luminaire includes forming a leveling layer over a concave interior surface. The leveling layer includes a porcelain enamel. A reflective surface is formed over the leveling layer. A lamp is mounted in an interior cavity of the reflector to illuminate the reflective surface when energized.

In another aspect, a reflector includes a substrate defining a concave interior surface. The interior surface has a first surface roughness. A leveling layer is supported on the concave interior surface of the substrate. The leveling layer includes an inorganic material which withstands temperatures in excess of 200° C. so as to maintain a level concave surface with a second surface roughness which is lower than the first surface roughness. A reflective layer comprising primarily silver is supported by the level concave surface.

An advantage of at least some aspects of the exemplary embodiment is that the proportion of specularly reflected light from a luminaire is increased.

Another advantage of at least some aspects of the exemplary embodiment is that equivalent illumination of a distant object may be achieved at a lower power consumption.

### BRIEF DESCRIPTION OF THE DRAWINGS

FIG. 1 is a schematic cross sectional view of a luminaire according to one aspect of the invention; and

FIG. 2 is an enlarged cross sectional view of a portion of the reflector of FIG. 1.

### DETAILED DESCRIPTION

Aspects of the exemplary embodiment relate to a reflector for a luminaire which is suited to use in exterior environments, such as to illuminate sports arenas and roadways. The reflector includes a layer of a leveling material which reduces surface irregularities in the reflector. The resulting luminaire has a high beam efficiency and is capable of operating at temperatures in excess of 100° C., in particular, temperatures in excess of 150° C., and which can exceed 200° C., without significant impairment to the beam efficiency. Accordingly, more of the light from the present lamp reaches the distant object that the luminaire is intended to illuminate than is the case for an otherwise identically formed conventional luminaire.

“Beam efficiency” can be defined as the ratio of the flux emitted by the luminaire inside the solid angle defined by the beam spread to the flux of the bare light source. The beam spread is generally considered to be the angle between points of 50% luminous intensity.

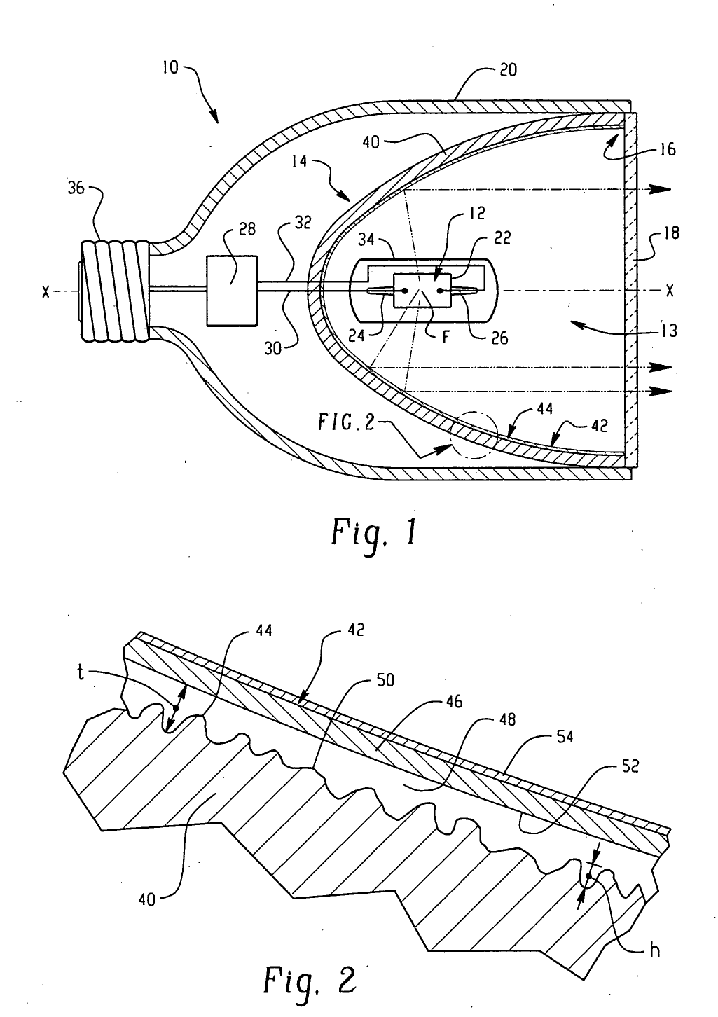

With reference to FIG. 1, one embodiment of a luminaire 10 is shown. The luminaire includes a light source 12 mounted within an interior cavity 13 of a generally concave reflector 14. The reflector 14 is provided with a light projection opening 16 to which a translucent cover 18, such as a lens, is attached. The lens 18 may serve as a refractor and/or to filter unwanted UV radiation from the light emitted from the luminaire, as well as to keep the optical elements clean. The reflector 14 may be mounted within a suitable housing 20 to provide protection from exterior environments and shock.

FIG. 1 illustrates a parabolic reflector 14, with the lamp 12 arranged at or near the reflector focus F, within the reflector interior cavity 12, and oriented with its length generally along the axis X-X of the reflector. Other configurations are also contemplated, such as elliptical or faceted reflectors or a perpendicularly oriented lamp. The light source 12 may be a high intensity discharge (HID) lamp having a wattage of from about 35-200W, or more, although other light sources, such as fluorescent or electroluminescent lamps or light emitting diodes, may be employed. A portion of the radiation from the lamp 12 is in the form of infrared (IR) radiation, which heats up the reflector 14, e.g., by radiation or convection.

The illustrated HID lamp 12 is a single-ended metal halide high intensity gas discharge lamp which includes an arc tube 22, made of quartz or ceramic. The arc tube 22 contains a suitable gaseous ionizable fill, such as a mixture of mercury and/or sodium vapor and/or one or more metal halides, and an inert gas. Tungsten electrodes 24, 26 extend into the fill and are supplied with electrical current from circuitry within a ballast housing 28 via respective conductors 30 and 32, Although FIG. 1 illustrates an integral ballast, it is to be appreciated that the ballast may be separate from the luminaire. An arc discharge is developed between the electrodes 24 and 26 during operation by excitation of the fill. Alternatively, the lamp 12 may be an electrodeless lamp wherein a discharge may be induced by an induction coil around the arc tube. Optionally, the arc tube 22 may be enclosed in an outer jacket 34, formed for example, from borosilicate glass or other UV-absorbing light transparent material. The lamp may be connected to a source of electrical power via a base 36. By way of example, a screw base-and-socket configuration may be used, as illustrated in FIG. 1. However, any suitable base-and-socket configuration may be employed, such as a plug type or bayonet type.

With reference also to FIG. 2, the reflector 14 includes a concave support body or substrate 40, which may be formed predominantly from aluminum, or other suitable malleable or otherwise formable material. Alternatively, the substrate may comprise two or more layers in which the interior layer is predominantly aluminum. The support body 40 defines the general shape of the reflector and supports a reflective surface 42 on a concave interior surface 44 thereof. The reflective surface 42 may be defined by a metallized reflective layer 46 formed primarily of silver or other suitable reflective material. Alternatively, the layer 46 may comprise a reflective dielectric coating comprising stacked layers of alternating high and low refractive index materials, such as titania and silica. A layer 48 of a leveling material intermediate the interior surface 44 and reflective layer 46 partially or entirely spaces the reflective surface 42 from the interior surface 44. In the illustrated embodiment, the leveling material layer 48 has a first surface 50 in contact with the aluminum body 40 and a second surface 52 in contact with the reflective layer 46, although additional layers may be provided intermediate the body 40 and the reflective layer 46. Optionally, a protective layer 54, such as one or more layers of silicon monoxide, silicon dioxide, titanium dioxide, aluminum oxide, or a combination thereof, may provide an outer layer of the reflector 14 to protect the silver layer 46 from environmental degradation.

As is evident from FIG. 2, the surface 44 of the support body 40 has a profile which has the appearance of projections and valleys under magnification. The height h of a tip of a projection from the bottom of a valley may be 0.1 μm or more and can be at least 0.5 μm and up to about 30 μm. In some embodiments, the aluminum surface 44 has a surface roughness of at least about 20 microns and in some embodiments, about 40-50 microns. Surface roughness may be measured with a surface profilometer according to ANSI standard B46.1 for Surface Roughness, Waviness, and Lay, Am. Soc. of Mech. Eng. (1986). The values obtained are the mean of the peak to valley measurements.

The leveling layer 48 has a thickness t which can be greater than the maximum height h of the projections such that tips of the projections are covered by the leveling material. However, even if the leveling layer 48 does not completely cover the tips of the projections, an increase may nevertheless be achieved in the smoothness of the resulting surface on which the reflective layer 46 is supported. The second surface 52 of the leveling layer 48 has a profile which is much smoother than the aluminum surface 44 and provides a smooth base for forming the reflective surface 42 thereon. The surface roughness of the leveling layer 48 may be less than about 10 μ, e.g., about 1-5 μm, or less, and in some embodiments, less than about 0.5 μm, or about 0.3 μm or less. The leveling layer 48 may be from about 1 to about 25 μm in thickness, and in one embodiment, is at least 10μm in thickness, e.g., at least 25 μm. In some embodiments, the thickness is less than about 80 μm, e.g., about 50 μm, or less.

The thickness of the reflective layer may be about between about 0.1 and about 1 μm, e.g., about 0.6 micrometers, or less. The reflective layer is configured to reflect most of the light in the visible region of the spectrum which impinges on the reflective surface 42. In general at least 85% and in some embodiments at least 90% or at least 94% of the visible light which impinges on the reflective surface 42 is reflected. The remainder of the light is absorbed or transmitted. As a result of the leveling layer 48, the proportion of reflected light which is specularly reflected by the reflector is increased, as compared with an equivalent luminaire where the leveling layer 48 is omitted. For example, the specular reflection may be increased from about 60-80% (without the leveling layer) to about 90% or higher, e.g., about 95% or higher (with the leveling layer). This increases the beam efficiency of the luminaire. The increased beam efficiency may be utilized to provide higher levels of illumination of distant objects than conventional luminaires. Or, the same level of illumination may be achieved at lower power consumption, for example, by utilizing a lower wattage lamp 12 than would otherwise be employed.

The protective layer 54 may be between about 0.05 and about 0.14 micrometers in thickness.

While the reflector 14 is illustrated as a single component, it is to be appreciated that the concave reflector may comprise two or more portions having different radii of curvature or different arrangements of facets. It is also contemplated that the leveling material 48 may be employed only in certain regions of the reflector and that in other regions, the reflective layer 46 may be in direct contact with the substrate 40. In general, the leveling material covers at least 50% of the reflector interior surface 44 which is covered by the reflective layer 46, and in some embodiments, at least 80% and up to 100% of the reflector interior surface.

The leveling layer 48 comprises a temperature resistant material which can withstand temperatures in excess of 100° C.-150° C. and in one embodiment, in excess of 200° C. without deforming, degrading, delaminating, or otherwise compromising the smoothness of the reflective surface 42. The reflector 14 may thus reach these temperatures in the regions closest to the lamp 12, when the lamp is operating for extended periods, without a reduction in beam efficiency. Inorganic materials capable of withstanding such temperatures are suitable for the leveling material.

In one embodiment, the leveling layer predominantly or entirely comprises a porcelain enamel which includes a fused mass of glass-forming materials. The glass forming materials are primarily present as components of oxide systems, but some may also be present as halides or chalcogenides, in multiple oxidation states, or in more complex compounds. In general, the word “oxides” will be used herein to refer to oxides of single elements and to mixed oxides, such as silicates, aluminates, titanates, and vanadates. Exemplary oxides include alkali metal oxides, alkaline-earth metal oxides, transition element oxides, and oxides of silicon and aluminum, such as oxides of one or more of Al, Si, Ti, V, Ba, K, B, Li, P, Mg, Na, Mo, Zn, La, Y, Nb, Zr, Sb, Sn, In, Cr, Fe, Mn, Cu, Ni, Co, Ce and Pb, and generally a combination of several oxides. In one embodiment, the leveling layer is substantially comprised of oxides, such as those listed and may comprise a total of at least 5% of oxides of titanium and vanadium.

Aluminum, the exemplary substrate material, has a melting point of about 660° C. Thus, enamel compositions which can be fused at relatively low temperatures, e.g., below about 650° C., and in one embodiment, below about 600° C., are suitable when the substrate 40 is predominantly aluminum or an aluminum alloy. Porcelain enamels have been used on aluminum surfaces, such as cookware and are described, for example, in U.S. Pat. No. 6,475,939 to Souchard, et al., U.S. Pat. No. 4,196,004 to Berretz, U.S. Pat. No. 5,266,357 to Preuss, et al., U.S. Pat. No. 6,936,556 to Sridharan, et al., and U.S. Pat. No. 6,566,289 to Aronica, et al. Such material may be used for the leveling layer 48.

The enamel may be formed by coating an aluminum substrate 40 with a slip comprising a glass frit and a liquid, primarily water. The glass frit may comprise fine particles of the above-mentioned oxides or of compounds which form the oxides on fusing. The coated substrate is then dried and fired to a suitable temperature to fuse the glass forming materials in the frit to form the enamel. An exemplary glass frit may comprise, by weight:

| Oxide | % by weight |
|---|---|
| SiO₂ | 10-60 |
| TiO₂ | 5-40 |
| Na₂O | 2-20 |
| B₂O₃ | 0-15 |
| K₂O | 5-20 |
| Li₂O | 1-11 |
| Sb₂O₃ | 0-8 |
| P₂0₅ | 0-20 |
| BaO | 0-3 |
| MgO | 0-3 |
| Al₂O₃ | 0-3 |
| V₂O₅ | 0.1-10 |

The glass frit may be formed by grinding a combination of raw materials, such as two or more of feldspar, borax, silica, fluorospar, soda ash, aluminum oxide, magnesium titanate and vanadate, lithium carbonate, and the like.

Exemplary glass frits are obtainable from Ferro Corp. under the tradename QT 330-4. Such frits are free of arsenic, lead, cadmium, and mercury since their primary use is in domestic applications, such as cookware. In the present application, these toxic materials need not necessarily be excluded. The frit may be selected to achieve a white enamel layer to increase reflection and minimize any modification of the color of the reflected light.

An exemplary process for forming the reflector is as follows. An aluminum blank of about 0.5-3 mm in thickness is formed into the shape of the reflector. The forming may be achieved by pressing the blank with a tool against a suitably shaped form such as a steel parabolic bowl or formed with hydrostatic pressure. During forming, the thickness may be reduced to about half the original thickness of the blank. The interior surface 44 of the shaped blank may be polished to reduce gross surface imperfections and/or etched with acid to yield a substantially oxide-free aluminum surface which enables good adherence of a suitable slip comprising the glass frit. Since the forming process may deposit oil on the interior surface 44, the surface is cleaned. Silicate containing cleaners are generally avoided as these may leave traces of silicates on the surface. The surface is then dried and cooled to room temperature prior to application of the slip.

As an alternative, the reflector substrate 40 may be formed by coating a body having the shape of the reflector body, e.g., by vacuum deposition of aluminum onto a shaped body formed from steel or other suitable material. The aluminum layer defines the interior surface of the reflector body with the steel serving as a support. The porcelain is laid down on the aluminum layer.

The slip may have a specific gravity of about 1.50-1.9, e.g., about 1.85, which may be achieved by combining the glass frit with water at a volume ratio of about 2:1. Additives, such as surfactants and other burnout materials, may be present in the slip in a total amount of less than about 5% by weight of the solids. Suspension aids, such as bentonite, may also be employed at about 0.2-5% by weight of the solids. The materials for the slip are mixed thoroughly and may be screened through a 100 mesh screen to remove agglomerations or large particles of frit.

Relatively high purity aluminum (>99% aluminum) is a good substrate material for achieving good adherence of the enamel. For example, 1100, 3002, and 3003 grade aluminum are suitable substrate materials. Aluminum alloys containing significant amounts of magnesium are generally undesirable, as at high firing temperatures, the magnesium can migrate to the surface and cause spalling. With lower purity substrate materials, a pre-coat may be applied to the interior surface 44 prior to application of the slip. The pre-coat may be an enamel or other suitable material having a higher adherence to the substrate but lack the desired surface smoothness provided by the slip.

The slip may be applied to the cleaned aluminum concave surface 44 at a thickness of, e.g., up to about 60-75 microns. The slip may be applied with an applicator, such as a spray gun, or by dip coating. Due to the abrasive nature of the frit, spray gun components are generally selected so as to minimize wear. For example, a spray gun fitted with a tungsten tip and nozzle may be used. The air pressure used in the spray gun is selected to minimize the chance that the frit will be applied in a dry state. If the air pressure is too high or the slip is too thick to atomize, the applied slip may be lumpy and in severe cases, result in spalling of the enamel or blistering. In general, air pressures of below about 40 psi are suitable. Once the slip has been applied, the reflector body is tapped gently or the leveling layer otherwise subjected to vibrations (e.g., with an ultrasonic treatment) to encourage the slip to spread evenly and form a smooth surface.

The sprayed reflector body is then dried, to reduce the water content, at a temperature of about 75° C. or lower, e.g., below about 65° C. Blistering may occur if the slip is dried at a temperature which is too high or if the residual water content is too high. The pH of the thus formed part may be about 11 or higher, and thus may react with the aluminum if the temperature is too high while the slip is still wet. IR lamps provide a good heat source for drying the slip. The drying time will vary depending on the thickness of the slip and its water content and on the oven temperature. A drying time of about 10 minutes is generally sufficient.

The dried reflector body is then fired at a sufficient temperature to fuse the inorganic material and form a glossy, smooth enamel. Suitable firing temperatures are below the melting point of the substrate 40 and in one embodiment, from about 500° C. to about 600° C., e.g., at least 530° C. For example, at a firing temperature of about 540-560° C., a firing time of about 1-6 minutes is generally sufficient. Since the firing temperature is close to the melting point of aluminum, care is taken to avoid deforming the reflector body during firing, for example, by suspending the reflector body or by providing a shaped support.

Optionally, a second layer of porcelain enamel may be deposited over the first layer of enamel. The second layer may be applied after drying the first layer and prior to firing.

The fired reflector body with the enamel coating is then metallized, for example, by sputtering, vacuum deposition, or otherwise coating, with a layer 46 of silver or other suitable reflective metal or other material. A protective layer or layers 54, such as a layer of silicon dioxide, which protects the silver layer 46 against oxidation and sulfide formation may then be deposited over the silver layer, for example, by sputtering silicon dioxide or a silicon-containing material from which the silicon dioxide layer can be generated. Alternatively, a multi-layer coating 46 of dielectric materials is formed, for example, by alternately sputtering silicon dioxide and titanium dioxide.

The lamp 12 is then mounted within the interior cavity 13 of the metallized reflector 14, and the end of the reflector closed with the cover 18. The lamp is electrically connected to the ballast. When energized, at least a portion of the light from the lamp is directed toward the reflector and is reflected therefrom as a collimated beam of light, as illustrated by the light rays in FIG. 1.

The luminaire may have a beam with a luminous intensity of at least about 400 and which can be up to about 2000 candela or higher. In some applications, the beam has a luminous intensity which exceeds 200,000 candela. The brightness of the beam can be about 1.5-2 times as high as an equivalent luminaire without the leveling layer. Alternatively, an equivalent brightness can be achieved with about half the wattage.

The invention has been described with reference to the preferred embodiments. Obviously, modifications and alterations will occur to others upon reading and understanding the preceding detailed description. It is intended that the invention be construed as including all such modifications and alterations.

What is claimed is:

1. A luminaire comprising:
a substrate having a concave interior surface;
a reflective surface supported by the substrate;
a leveling layer intermediate the substrate and the reflective surface, the layer comprising a porcelain enamel; and
a light source which illuminates the reflective surface.

2. The luminaire of claim 1, wherein the porcelain enamel comprises a fused mixture of one or more oxides.

3. The luminaire of claim 1, wherein the porcelain enamel includes a plurality of oxides selected from the group consisting of Al, Si, Ti, V, Ba, K, B, Li, P, Mg, Na, Mo, Zn, La, Y, Nb, Zr, Sb, Sn, In, Cr, Fe, Mn, Cu, Ni, Co, Ce, and P.

4. The luminaire of claim 1, wherein the porcelain enamel includes oxides of Ti and V in a total amount of at least 5% of the enamel.

5. The luminaire of claim 1, wherein the leveling layer has a thickness of at least 10 micrometers.

6. The luminaire of claim 1, wherein the leveling layer has a thickness of less than about 250 micrometers.

7. The luminaire of claim 1, wherein the substrate comprises primarily aluminum.

8. The luminaire of claim 1, wherein the light source comprises a high intensity discharge lamp which, when energized, heats an adjacent region of the leveling layer to a temperature of at least 150° C.

9. The luminaire of claim 1, wherein the leveling layer has a first surface in contact with an interior surface of the substrate and a second surface in contact with a reflective layer which defines the reflective surface.

10. The luminaire of claim 9, wherein the reflective layer is predominantly silver.

11. The luminaire of claim 9, wherein the second surface has a lower surface roughness than the interior surface of the substrate.

12. The luminaire of claim 1, further comprising a translucent cover located at a light projection opening of the luminaire.

13. A method for forming a luminaire comprising:
forming a leveling layer over a concave interior surface, the leveling layer comprising a porcelain enamel;
forming a reflective surface over the leveling layer; and
mounting a lamp to illuminate the reflective surface when energized.

14. The method of claim 13, wherein the forming of the leveling layer comprises:
coating the concave interior surface with a slip comprising a glass frit; and
firing the glass frit on the concave interior surface at a sufficient temperature to form the porcelain enamel.

15. The method of claim 14, wherein the temperature is less than 650° C. and the interior surface is defined by a substrate comprising aluminum.

16. The method of claim 13, further comprising at least one of tapping and vibrating the interior surface coated with the slip prior to firing to increase a surface smoothness of the porcelain enamel.

17. The method of claim 13, wherein the glass frit includes oxides of titanium and vanadium.

18. The method of claim 13, wherein the leveling layer has a surface roughness which is lower than that of the concave interior surface.

19. A reflector comprising:
a substrate defining a concave interior surface with a first surface roughness;
a leveling layer supported on the concave interior surface of the substrate, the leveling layer comprising an inorganic material which withstands temperatures in excess of 200° C. so as to maintain a level concave surface with a second surface roughness which is lower than the first surface roughness; and
a reflective layer comprising primarily silver supported by the level concave surface.

20. The reflector of claim 19, wherein the substrate is primarily aluminum.
